(19) United States
(12) Patent Application Publication
(10) Pub. No.: US 2011/0041290 A1
(43) Pub. Date: Feb. 24, 2011

(54) STRAP FOR PIVOTABLY FASTENING A LEAF OF A DOOR, OF A WINDOW OR THE LIKE TO A FIXED FRAME

(75) Inventors: Tibor Herglotz, Kreuzau (DE); Ingo Steinfeld, Langenfeld (DE)

Correspondence Address: PATENT LAW OFFICES OF DR. NORMAN B. THOT, POSTFACH 10 17 56, RATINGEN, 40837, DE

(73) Assignee: DR. HAHN GMBH & CO., KG, MOENCHENGLADBACH-WICKRATH (DE)

(21) Appl. No.: 12/922,691

(22) PCT Filed: Mar. 13, 2009
(86) PCT No.: PCT/EP09/52969

§ 371 Date: Sep. 15, 2010

(30) Foreign Application Priority Data
Mar. 17, 2008 (DE) 202008003694.1

(51) Int. Cl. E05D 11/06

(52) U.S. Cl. 16/375

(57) ABSTRACT

A hinge includes a frame hinge element configured to be attached to a fixed frame, a leaf hinge element configured to be attached to a leaf, a connecting device configured to couple the frame hinge element to the leaf hinge element. The connecting device is mounted on the frame hinge element to pivot about a frame articulation axis and on the leaf hinge element to pivot about a leaf articulation axis. A restraining device is configured to block either the frame hinge element or the leaf hinge element. The frame hinge element/leaf hinge element comprises a fixed receptacle and a bearing device. The bearing device is configured to shift from the receptacle. The connecting device is coupled to the bearing device. An adjusting device is configured to shift the fixed receptacle relative to the bearing device when the connecting device is pivoted about the articulation axis out of a closed leaf position.

### CROSS REFERENCE TO PRIOR APPLICATIONS

This application is a U.S National Phase application under 35 U.S.C. §371 of International Application No. PCT/EP2009/052969, filed on Mar. 13, 2009 and which claims benefit to German Petty Patent Application No. 20 2008 003 694.1, filed on Mar. 17, 2008. The International Application was published in German on Sep. 24, 2009 as WO 2009/115458 A1 under PCT Article 21(2).

### FIELD

The present invention relates to a hinge for pivotably fastening a leaf of a door, of a window or the like to a fixed frame, with a frame hinge element which can be fixed to the frame, with a leaf hinge element which can be fixed to the leaf, with a connecting element, which couples the frame hinge element to the leaf hinge element and is mounted on the frame hinge element so as to be pivotable about a frame articulation axis and is mounted on the leaf hinge element so as to be pivotable about a leaf articulation axis running parallel to the frame articulation axis, and with restraining means which block the capability of the connecting element to pivot about one of the articulation axes at opening angles of the leaf below a limit angle.

### BACKGROUND

A hinge of this type is described in DE 101 05 264 C1.

In this hinge, the frame hinge element and the leaf hinge element are configured in such a manner that the frame and leaf articulation axes are arranged completely within cavities in the frame or leaf. The restraining means are intended to bring about a clearly defined sequence of movement on the frame and leaf pivot axes and therefore to avoid uncontrolled relative movements occurring between the leaf and the frame.

A disadvantage of the hinge, however, is that due to the connecting element being pivoted in each case only about one of the two frame and leaf articulation axes (depending on the opening angle of the leaf), during opening those edges of the leaf which are located closest to the frame first of all describe a movement in a small radius about that articulation axis about which the pivoting takes place at small opening angles. Depending on the design of the frame and/or of the leaf, collisions may therefore occur between the frame and the leaf, and therefore the use of the hinge is restricted.

### SUMMARY

An aspect of the present invention therefore provides a hinge in which, during opening of the leaf out of the closed position thereof, those regions of the leaf which are situated closest to the frame at least initially, as the opening angle increases, describe a path of movement with an increasing distance from the frame.

In an embodiment, the present invention provides a hinge for pivotably fastening a leaf to a fixed frame which includes a frame hinge element configured to be attached to the fixed frame, a leaf hinge element configured to be attached to the leaf, at least one connecting device configured to couple the frame hinge element to the leaf hinge element. The at least one connecting device is mounted on the frame hinge element so as to pivot about a frame articulation axis and on the leaf hinge element so as to pivot about a leaf articulation axis running parallel to the frame articulation axis. A restraining device is configured to block either the frame hinge element or the leaf hinge element from pivoting about one of the articulation axis or the leaf articulating axis at an opening angle of the leaf below a limit angle. The frame hinge element and the leaf hinge element which is not blocked from pivoting at the opening angle below the limit angle comprises a fixed receptacle and a bearing device. The bearing device is configured to be shiftable from the receptacle perpendicularly to the leaf articulation axis. The at least one connecting device is coupled to the bearing device. An adjusting device is configured to shift the fixed receptacle relative to the bearing device when the at least one connecting device is pivoted about the articulation axis out of a closed leaf position.

### BRIEF DESCRIPTION OF THE DRAWINGS

The present invention is described in greater detail below on the basis of embodiments and of the drawings in which:

FIG. 1 shows the leaf hinge element which is configured according to the present invention together with a connecting element in a perspective exploded illustration;

FIG. 2 shows a sectional view A-A of an embodiment, fitted on a leaf which is butt-jointed to a frame, with the leaf closed, in a view in the direction of the articulation axes;

FIG. 3 shows an embodiment in the same view as in FIG. 2 with the leaf opened approximately by 20°;

FIG. 4 shows an embodiment in a view corresponding to FIG. 2 with the leaf opened by approximately 90°, and

FIG. 5 shows a an embodiment in an illustration corresponding to FIG. 4.

### DETAILED DESCRIPTION

Owing to the fact that, in the case of the hinge according to the present invention, that element of the frame hinge element or of the leaf hinge element in which the capability to pivot at opening angles below the limit angle is not blocked has a fixed receptacle and a bearing device which is mounted so as to be shiftable from the receptacle perpendicularly to the leaf articulation axis, to the fact that the connecting element is coupled to the bearing device, and to the fact that an adjusting device is provided, the adjusting device causing the receptacle to shift relative to the bearing device when the connecting element is pivoted about the articulation axis out of the closed leaf position, not only does pivoting about the articulation axis which is initially not blocked take place at small opening angles of the leaf but those regions of the leaf which are situated closest to the frame describe a path curve with a directional component continuing radially away from the articulation axis. Owing to said measure, even at small opening angles of the leaf, a relatively large clearance is brought about between the leaf and the frame, and therefore the hinge according to the present invention can be used in a more versatile manner.

In particular if, in the case of leafs butt-jointed to a frame, the hinge according to the present invention is intended to be used in an arrangement concealed when the leaf is closed, it can be advantageous if the hinge element in which the capability to pivot at opening angles below the limit angle is not blocked is the leaf hinge element.

The adjusting device can basically be configured in any manner bringing about the relative movement between the receptacle and the bearing device during opening of the leaf. A structural design of the adjusting device can, for example, comprise an adjusting lever, the first end of which is coupled to the receptacle so as to be pivotable about a first axis parallel to the leaf or frame articulation axis, and the second end of which is coupled to the connecting element at a distance from the leaf or frame articulation axis so as to be pivotable about a second axis parallel to the leaf or frame articulation axis. By means of the movement transmitted to the adjusting lever with the aid of the connecting element when the leaf is pivoted, the adjusting lever pivots about the first axis thereof, as a result of which the length thereof which is effective in the shifting direction changes and the receptacle and bearing device are shifted relative to each other. This configuration of the adjusting device is distinguished by the structurally simple design thereof and the functional reliability thereof.

In order, at small opening angles, to bring about as large a movement component as possible perpendicular to the articulation axis about which the pivoting movement takes place, when the leaf is closed, the adjusting lever should be in a position in which a connecting line between the first and second axes thereof runs as virtually perpendicular as possible to the shifting direction. This can be met structurally in that, in the position corresponding to the closed leaf, the first axis is provided on the one side of the center plane of the bearing device, said center plane extending in the shifting direction parallel to the leaf articulation axis, and the second axis is provided on the other side of the center plane.

In order to provide a virtually play-free, permanently smooth-running relative shifting between the bearing device and the receptacle, the receptacle can, for example, comprise at least one guide recess which extends in the shifting direction and in which a guide extension provided on the bearing device engages.

In order to keep the specific forces transmitted between the receptacle and the bearing device as small as possible, it can be advantageous if the guide extensions interact as extensively as possible with the guide recesses. The guide extensions and the guide recesses can, for example, be formed in such a manner that the guide extensions protrude through the guide recesses irrespective of the respective opening angle.

In order to further increase the load-bearing capacity and the operational reliability of a hinge according to the present invention configured in such a manner, those ends of the guide extensions which protrude out of the guide recesses can be connected to one another, for example, by means of a bridge. Owing to this configuration, it can be reliably avoided that the guide extensions, when subjected to a load, are twisted relative to one another transversely with respect to the shifting direction, which could result in an increase in the wear when the hinge is operated or even in complete jamming.

The load-bearing capacity of the hinge according to the present invention can be increased once again by two connecting elements being provided at a distance from each other in the direction of the leaf articulation axis. This configuration makes it possible, for example, to provide, between the two connecting elements, an additional arrangement of a guide extension on the bearing device and associated guide recess in the receptacle.

The restraining means can in turn be configured in any manner allowing the clearly defined sequence of movement on both frame and leaf pivot axes. For example, it is conceivable, as described in DE 101 05 264 C1, to provide a torsion spring which provides such a large restraining value for the associated pivot axis that, during the opening of the leaf, the pivoting movement is first or all entirely carried out by the other articulation axis as far as a stop and is subsequently continued by said articulation axis by the spring force being overcome.

Since, however, at high leaf weights or upon transverse forces acting on the leaf during the opening or closing of the leaf, a rotational movement can also take place before the end position is reached by the spring force being overcome, a configuration of the hinge according to the present invention can, for example, comprise a pawl arrangement with a lever which is arranged on the connecting element so as to be pivotable about a parallel to the leaf articulation axis, and with cam arrangements which are provided on the frame element and on the leaf element and with which the lever interacts. Such a configuration of the restraining means is described in DE 20 2005 000 064 U1 to which reference is made with regard to the details of the configuration.

If, for example, two connecting elements are provided at a distance from each other in the direction of the leaf articulation axis, the lever of the pawl arrangement can, for example, be arranged between the connecting elements. It can be positioned by means of a bolt which defines the pivot axis of the lever and which protrudes into bores provided for this purpose in the two connecting elements.

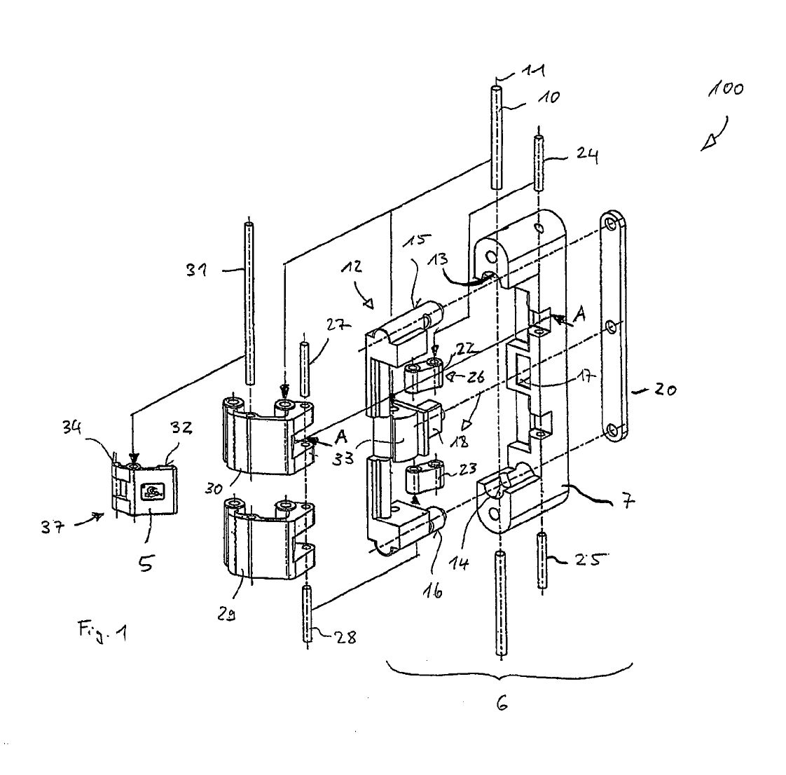

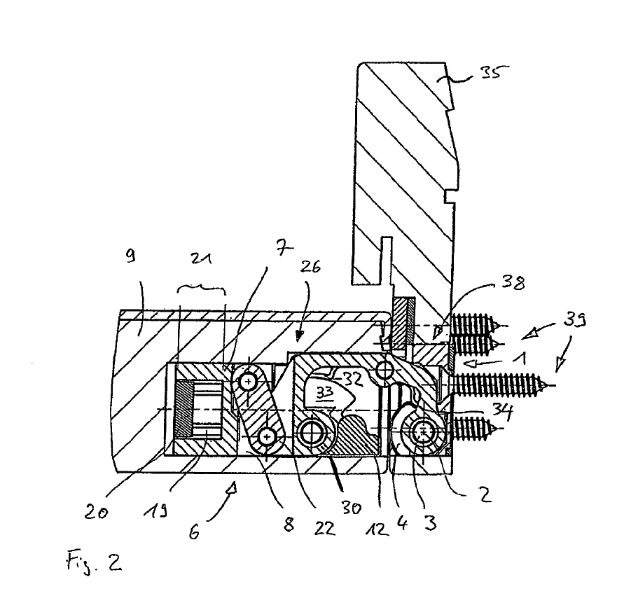

In an embodiment of the present invention, denoted as a whole by 100, the hinge comprises a frame hinge element 1 which is not illustrated in FIG. 1 and comprises a receptacle for a frame hinge pin 3 defining the frame articulation axis 2. As can furthermore be gathered from FIGS. 2 to 4, the frame hinge element 1 comprises a cam 4 on which one end of a lever 5, which is described in detail below, slides upon operation of the hinge 100. The frame hinge element 1 is inserted into a cutout 38 in the frame 35 and is fastened to said frame by means of tapping screws 39.

The hinge 100 furthermore comprises a leaf hinge element 6, which is illustrated in FIG. 1. Said leaf hinge element comprises a receptacle 7 which can be fixed in a cutout 8 to be provided in a leaf 9 (see FIG. 2).

The receptacle 7 serves for the mounting of a bearing device 12, which mounting is displaceable perpendicularly to a leaf articulation axis 11 defined by a leaf hinge pin 10. For this purpose, two mutually facing, cross-sectionally semicircular guide recesses 13, 14, in which the bearing device 12 engages by means of complementary guide extensions 15, 16, are provided on the receptacle 7. A further guide recess 17 of rectangular cross section, into which a complementary, further guide extension 18 of the bearing device 12 protrudes, is provided in the receptacle 7 between the guide recesses 13, 14.

The guide recesses 13, 14, 17 open into a longitudinal cutout 19 located, according to FIG. 1 on the rear side of the receptacle 7 (see FIG. 2). The length of the guide extensions 15, 16, 18 is dimensioned in such a manner that the ends of the guide extensions protrude into the longitudinal cutout 19 and are connected to each other therein via a bridge 20.

The longitudinal cutout has a depth 21 which permits the bearing device 12 to be shiftable relative to the receptacle 7 in the shifting direction defined by the guide extensions 15, 16, 18 in the guide recesses 13, 14, 17.

Two adjusting levers 22, 23 are coupled via journals 24, 25 to the receptacle 7 in a manner offset, according to FIG. 1, out of the center plane of the receptacle 7 toward the observer. The adjusting levers 22, 23 form parts of an adjusting device 26 which serves for the relative shifting of the bearing device 12 relative to the receptacle 7 upon operation of the hinge 100. For this purpose, the other ends of the adjusting levers 22, 23 are coupled with the aid of journals 27, 28 to two connecting elements 29, 30 which couple the frame hinge element (not illustrated in FIG. 1) to the leaf hinge element.

The connecting elements 29, 30 for their part are mounted pivotably in the bearing device 12 with the aid of the leaf hinge pins 10.

The two connecting elements 29, 30 are at a distance from each other which corresponds approximately to the width of the lever 5. The latter is mounted pivotably relative to the connecting elements 29, 30 by means of a journal 31 between the latter.

All of the journals and the pivot axes defined thereby run parallel to the frame and leaf articulation axes 2, 11.

At the end region 32 thereof on the leaf side, the lever 5 interacts with a cam 33 which is provided on the bearing device 12, and the end region 34 on the frame side interacts with the cam 4 provided on the frame hinge element.

The functioning of the hinge 100 will now be explained with reference to FIGS. 2 to 4.

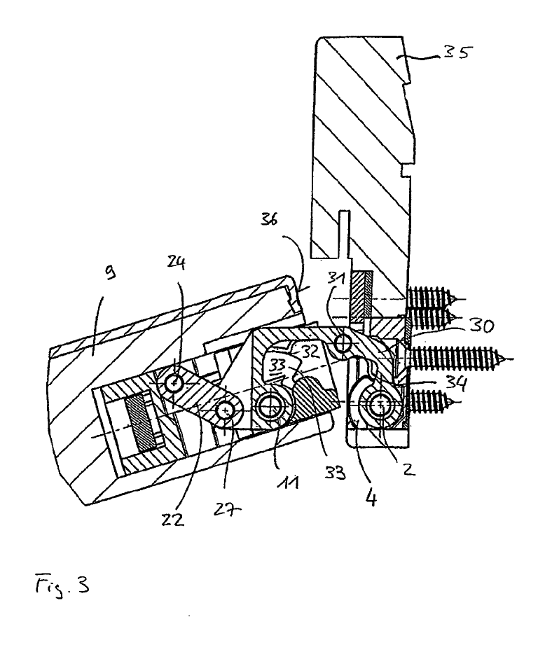

If the leaf 9, according to FIGS. 2 to 4, is pivoted downward in relation to the frame 35 in the opening direction, the levers 22, 23, of which only the lever 22 can be seen in FIGS. 2 to 4, by being coupled at one end to the receptacle 7 and at the other end to the connecting elements 29, 30, cause the bearing device 12 to be displaced relative to the receptacle 7 perpendicularly to the articulation axes. As is evident in particular from FIG. 3, said displacement results in the narrow side 36 of the leaf 9, which narrow side faces the frame 35, being moved away from the frame 35 even at small opening angles and therefore a relatively large clearance being formed between the leaf 9 and the frame 35. The restraining means 37 which are formed by the lever 5 and the cam 4, 33 and which are described in DE 20 2005 000 064 U1, provide that, at a small angle, the pivoting initially takes place only about the leaf articulation axis 11, by that end region 34 of the lever 5 which is on the frame side engaging in a recess in the cam 4, blocking a pivoting of the connecting elements 29, 30 about the frame articulation axis 2 and at the same time releasing the pivoting about the leaf articulation axis 11.

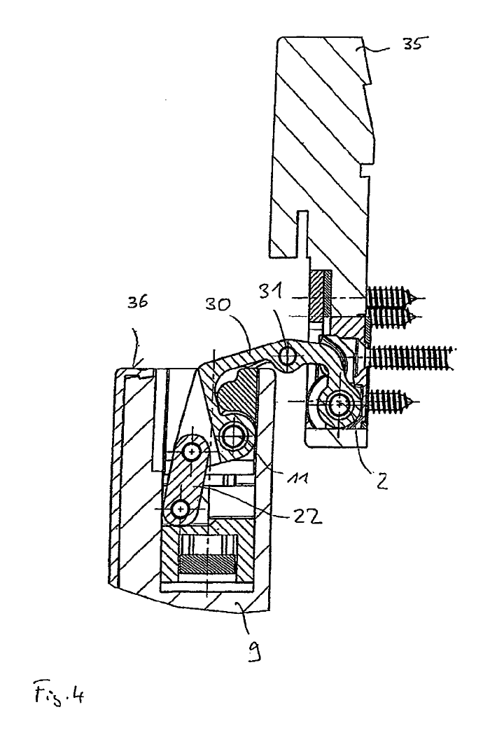

As can furthermore be seen in particular by comparison of FIGS. 2 to 4, the maximum deflection of the bearing element 12 out of the inoperative position thereof, which is illustrated in FIG. 2, is achieved when the adjusting lever pivot axes, which are defined by the journals 27, 28 and 24, 25, lie in one plane with the leaf articulation axis 11. This state is not yet reached in the case of the opening angle illustrated in FIG. 3. If the leaf is opened further, for example as far as the opening angle illustrated in FIG. 4, the further pivoting of the adjusting levers 22, 23 beyond the above-described maximum position has the effect that the bearing element 12 in turn is pulled back further into the receptacle 7.

In an illustrated embodiment, the cams 4, 33 are designed in such a manner that the leaf 9 is pivoted in relation to the frame 35 exclusively about the leaf articulation axis 11 until an opening position of approximately 90° is obtained. When said opening position is reached, that end region of the lever 5 which is on the leaf side opens into a depression in the cam 33. By means of the tilting movement brought about by this means, the cam 4 is released and the further pivoting takes place exclusively about the frame articulation axis 2.

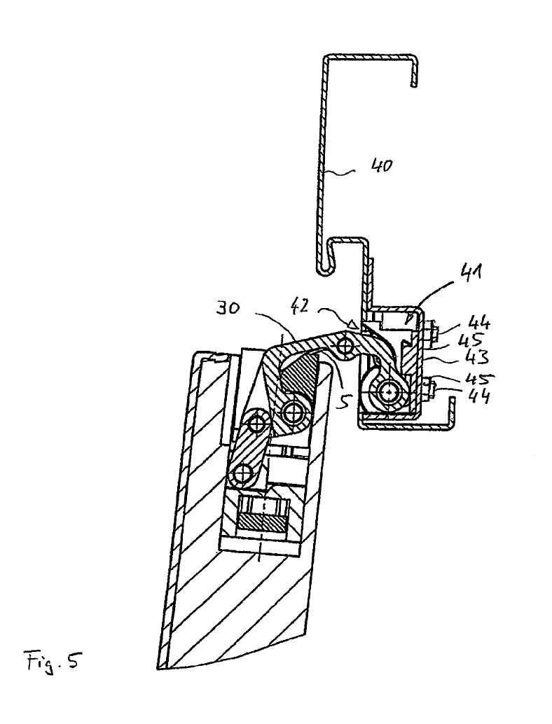

An embodiment of the present invention denoted as a whole by 200 is illustrated in FIG. 5. The function thereof substantially corresponds to that of the aforementioned embodiment. In order to avoid repetitions only the differences from the aforementioned embodiment will be discussed below.

The hinge 200 is provided for fastening to a frame profile 40 which is produced by bending of a flat material. For this purpose, said frame profile comprises a profile chamber 41 which has an opening 42 which is incorporated into the frame profile and through which the connecting elements 29, 30 and the lever 5 protrude. Toward the inside of the profile, illustrated on the right in FIG. 5, the profile chamber is bounded by a cap 43 connected to the profile 40 with a cohesive material joint.

The frame hinge element 1 is fastened in the profile chamber by means of machine screws 44 which are screwed into nuts 45 provided on the outside of the cap 42.

The present invention is not limited to embodiments described herein; reference should be had to the appended claims.

### List of Reference Numbers:

100, 200 Hinge

1 Frame hinge element

2 Frame articulation axis

3 Frame hinge pin

4 Cam

5 Lever

6 Leaf hinge element

7 Receptacle

8 Cutout

9 Leaf

10 Leaf hinge pin

11 Leaf articulation axis

12 Bearing device

13 Guide recess

14 Guide recess

15 Guide extension

16 Guide extension

17 Guide recess

18 Guide extension

19 Longitudinal cutout

20 Bridge

21 Depth

22 Adjusting lever

23 Adjusting lever

24 Journal

25 Journal

26 Adjusting device

27 Journal

28 Journal

29 Connecting element

30 Connecting element

31 Journal

32 End region on the leaf side

33 Cam

34 End region on the frame side

35 Frame

36 Narrow side

37 Restraining means

38 Cutout

39 Screws

40 Frame profile

41 Profile chamber

42 Opening

43 Cap

44 Machine screws

45 Nuts

1-10. (canceled)

11. A hinge for pivotably fastening a leaf to a fixed frame, the hinge comprising:
a frame hinge element configured to be attached to the fixed frame;
a leaf hinge element configured to be attached to the leaf;
at least one connecting device configured to couple the frame hinge element to the leaf hinge element, the at least one connecting device being mounted on the frame hinge element so as to pivot about a frame articulation axis and on the leaf hinge element so as to pivot about a leaf articulation axis running parallel to the frame articulation axis;
a restraining device configured to block either the frame hinge element or the leaf hinge element from pivoting about one of the articulation axis and the leaf articulating axis at an opening angle of the leaf below a limit angle, wherein the frame hinge element or the leaf hinge element which is not blocked from pivoting at the opening angle below the limit angle comprises a fixed receptacle and a bearing device, the bearing device being configured to be shiftable from the receptacle perpendicularly to the leaf articulation axis, and wherein the at least one connecting device is coupled to the bearing device; and
an adjusting device configured to shift the fixed receptacle relative to the bearing device when the at least one connecting device is pivoted about the articulation axis out of a closed leaf position.

12. The hinge as recited in claim 11, wherein a hinge element which is not blocked from pivoting at the opening angle below the limit angle is the leaf hinge element.

13. The hinge as recited in claim 11, wherein the adjusting device includes an adjusting lever having a first end and a second end, the first end being configured to couple to the receptacle so as to pivot about a first axis parallel to the leaf articulation axis, and the second end being configured to couple to the at least one connecting device at a distance from the leaf articulation axis so as to pivot about a second axis parallel to the leaf articulation axis.

14. The hinge as recited in claim 13, wherein, in a closed-leaf position, the first axis is provided on a first side of a center plane of the bearing device, the center plane extending in a shifting direction parallel to the leaf articulation axis, and the second axis is provided on a second side of the center plane.

15. The hinge as recited in claim 11, further comprising a guiding device disposed on the bearing device, wherein the receptacle includes at least one guide recess extending in a shifting direction which is configured to engage a guide extension.

16. The hinge as recited in claim 15, wherein the at least one guide extension and the at least one guide recess are configured so that a guide extension protrudes through a guide recess.

17. The hinge as recited in claim 16, further comprising a bridge configured to connect guide extension ends protruding from guide recesses.

18. The hinge as recited in claim 11, wherein the at least one connecting device includes a first connecting device and a second connecting device disposed at a distance from each other in a direction of the leaf articulation axis.

19. The hinge as recited in claim 11, wherein the restraining device includes a pawl arrangement with a lever, the lever being disposed on the at least one connecting device and being configured to pivot about a parallel to the leaf articulation axis, and with cam arrangements disposed on each of the frame hinge element and on the leaf hinge element, the cam arrangements being configured to interact with the lever.

20. The hinge as recited in claim 19, wherein the lever is disposed between a first connecting device and a second connecting device.

21. The hinge as recited in claim 11, wherein the leaf is the leaf of a door or a window.
